(19) United States
(12) Patent Application Publication
(10) Pub. No.: US 2010/0247895 A1
(43) Pub. Date: Sep. 30, 2010

(54) ARTIFICIAL LEATHER FOR AUTOMOBILE INTERIOR MATERIALS AND METHOD FOR PRODUCING THE SAME

(76) Inventors: Tomoyuki UEMURA, Wako-shi (JP); Shigeru TADOKORO, Osaka (JP); Yukito KANEKO, Fukui-shi (JP)

Correspondence Address: JORDAN AND HAMBURG LLP, 122 EAST 42ND STREET, SUITE 4000, NEW YORK, NY, 10168, US

(21) Appl. No.: 12/749,821

(22) Filed: Mar. 30, 2010

(30) Foreign Application Priority Data
Mar. 31, 2009 (JP) 2009-085875

(51) Int. Cl. B32B 27/40; C09J 175/04; B32B 7/12

(52) U.S. Cl. 428/317.7; 156/331.7

(57) ABSTRACT

An artificial leather comprises a fibrous substrate having laminated on one side thereof an adhesive layer comprising a polyurethane resin formed by a moisture curing reaction of a urethane polyisocyanate prepolymer, a surface layer comprising a polyurethane resin formed by a reaction between a urethane polyol prepolymer and a urethane hardener, and a protective layer comprising a polyurethane resin, in this order. The urethane polyol prepolymer used in the formation of the surface layer is obtained by reacting a polyol containing polyether polyol, and a polyisocyanate, and weight proportion of the polyether polyol is 40% by weight or more based on the total weight of the urethane polyol prepolymer and the urethane hardener. The polyurethane resin constituting the surface layer has 100% modulus value of from 5 to 50 N/cm, and the surface layer has a degree of foaming of from 1.3 to 2.0 times.

### CROSS-REFERENCE TO RELATED APPLICATIONS

This application is based upon and claims the benefit of priority from the prior Japanese Patent Application No. 2009-85875, filed on Mar. 31, 2009; the entire contents of which are incorporated herein by reference.

### FIELD OF THE INVENTION

The present invention relates to artificial leather having natural leather-like touch and feeling, and particularly preferably used as automobile interior materials, and a method for producing the same.

### BACKGROUND OF THE INVENTION

Conventionally, artificial leather is used in automobile interior materials as a substitute for natural leather or as a leather material having properties better than those of natural leather. The artificial leather is generally obtained by laminating a polyurethane resin layer on a substrate comprising a fibrous material (for example, non-woven fabric, woven fabric and knitted fabric) in order to obtain natural leather-like touch and feeling.

The artificial leather having natural leather-like touch and feeling includes artificial leather obtained by impregnating or applying a fibrous substrate with a polyurethane resin, wet-coagulating the polyurethane resin to form a wet fine porous layer, and forming a polyurethane resin surface layer on the surface of the wet fine porous layer, and artificial leather obtained by bonding a wet grain layer obtained by wet coagulation of a polyurethane resin to a fibrous substrate through an adhesive (both are wet artificial leather) (see, for example, Japanese Unexamined Patent Publication JP-A 05-44173 (1993), JP-A 06-108368 (1994) and JP-A 09-31859 (1997)).

On the other hand, artificial leather having excellent properties such as abrasion resistance includes artificial leather having a surface layer formed using, for example, a hot-melt urethane prepolymer having an isocyanate group at the molecular terminal, that is, a moisture curing hot-melt polyurethane resin (see JP-A 2005-273131).

However, the artificial leathers disclosed in JP-A 05-44173 (1993), JP-A 06-108368 (1994) and JP-A 09-31859 (1997) have a wet fine porous layer, and therefore have the problem that sufficient abrasion resistance is not obtained as artificial leather for automobile interior materials and the problem that environmental load is large due to the use of a solvent in a production process.

On the other hand, the artificial leather disclosed in JP-A 2005-273131 is obtained by directly bonding a surface layer comprising a moisture curing hot-melt polyurethane resin to a fibrous substrate, and therefore has the problem that ununiform pores are formed in the polyurethane resin surface layer, and touch and feeling become coarse and hard.

### SUMMARY OF THE INVENTION

One object of the present invention is to provide artificial leather having small environmental load, natural leather-like touch and feeling, and sufficient durability, particularly abrasion resistance, as artificial leather for automobile interior materials. Another object of the present invention is to provide a method for producing the artificial leather.

The artificial leather for automobile interior materials according to the present invention comprises a fibrous substrate, an adhesive layer comprising a polyurethane resin formed by a moisture curing reaction of a urethane polyisocyanate prepolymer, formed on one side of the fibrous substrate, a surface layer comprising a polyurethane resin formed by a reaction between a urethane polyol prepolymer and a urethane hardener, formed on the adhesive layer, and a protective layer comprising a polyurethane resin, formed on the surface layer. The urethane polyol prepolymer used in the formation of the surface layer is obtained by reacting a polyol containing a polyether polyol with a polyisocyanate, and a weight proportion of the polyether polyol is 40% by weight or more based on the total weight of the urethane polyol prepolymer and the urethane hardener. The polyurethane resin constituting the surface layer has 100% modulus value of from 5 to 50 N/cm, and the surface layer has a degree of foaming of from 1.3 to 2.0 times.

The method for producing artificial leather for automobile interior materials comprises:

a step of mixing a urethane polyol prepolymer in a heated state and a urethane hardener to prepare a prepolymer composition,

a step of applying the prepolymer composition in a heated state to a releasable substrate to form a surface layer, and a step of applying a urethane polyisocyanate prepolymer in a heated state to the surface layer, and bonding a fibrous substrate to the surface applied with the urethane polyisocyanate prepolymer (hereinafter referred to as the coated surface).

According to the present invention, artificial leather having natural leather-like touch and feeling and having excellent durability such as abrasion resistance can be produced with a process having small environmental load.

### BRIEF DESCRIPTION OF THE DRAWINGS

FIG. 1 is a schematic cross-sectional view of the artificial leather for automobile interior materials according to one embodiment of the present invention.

FIG. 2 is a schematic cross-sectional view in a production stage of the artificial leather for automobile interior materials.

### DETAILED DESCRIPTION OF THE INVENTION

The artificial leather for automobile interior materials according to the present invention comprises a fibrous substrate having laminated on one side thereof an adhesive layer comprising a polyurethane resin formed by a moisture curing reaction of a urethane polyisocyanate prepolymer, a surface layer comprising a polyurethane resin formed by a reaction between a urethane polyol prepolymer and a urethane hardener, and a protective layer comprising a polyurethane resin, in this order.

The fibrous substrate used in the present invention is not particularly limited, and examples of the fibrous substrate used include fibrous fabrics such as woven fabric, knitted fabric and non-woven fabric, and natural leather. The fibrous substrate is appropriately selected according to the purpose of use of the artificial leather. The kind of fiber in the fibrous fabrics is not particularly limited, and examples of the fiber used include the conventional fibers such as natural fiber, regenerated fiber, semi-synthetic fiber and synthetic fiber. The fiber may be used as mixtures of two kinds or more thereof. Above all, knitted fabric comprising synthetic fiber, particularly knitted fabric comprising polyester fiber, is preferably used from the points of strength and processability.

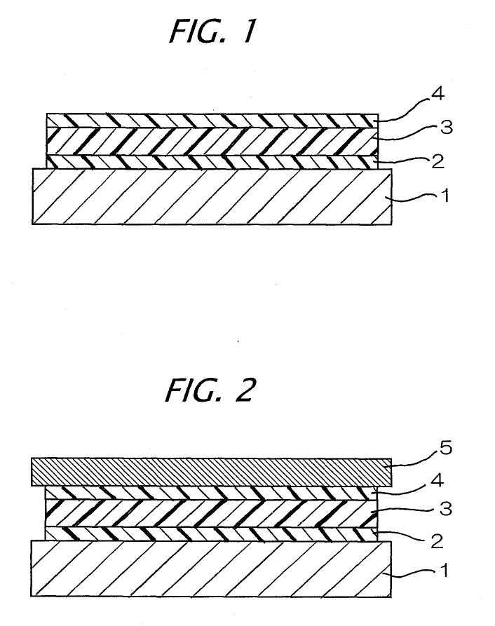

The artificial leather for automobile interior materials according to the present invention comprises a fibrous substrate 1 having laminated on one side thereof an adhesive layer 2, a surface layer 3, and a protective layer 4 (those layers all comprise a polyurethane resin), in this order as its one embodiment is shown in FIG. 1.

The surface layer is described below.

In the present invention, the surface layer comprises a polyurethane resin formed by a reaction between a urethane polyol prepolymer and a urethane hardener. The urethane polyol prepolymer used herein means a urethane prepolymer having a hydroxyl group at the molecular terminal. The polyurethane resin is a general name of a polymer compound having a urethane bond (—NHCOO—) as conventionally known, and is generally produced by reacting a polyol and a polyisocyanate (crosslinking/curing reaction). A urethane prepolymer is obtained by stopping the reaction between a polyol and a polyisocyanate at an appropriate stage, has a urethane bond in the main chain, and is used as a base compound in forming a polyurethane resin. The urethane prepolymer has two types depending on proportions of a polyol and a polyisocyanate at the time of production; one is a urethane polyol prepolymer having a hydroxyl group at the molecular terminal, and another is a urethane polyisocyanate prepolymer having an isocyanate group at the molecular terminal. Of those, the urethane polyol prepolymer is selected and used in the surface layer. Hydroxyl group present at the molecular terminal of the urethane polyol prepolymer reacts with an isocyanate group of a polyisocyanate used as a urethane hardener to form a urethane bond, and as a result, a polyurethane resin is formed. Furthermore, the isocyanate group reacts with water (moisture) in the atmosphere, other than the reaction with a hydroxyl group, thereby generating carbon dioxide gas. Thus, the surface layer converts into a foamed layer having many pores formed therein.

The urethane polyol prepolymer can be produced by reacting a polyol and a polyisocyanate under the condition that hydroxyl groups of the polyol are excess to isocyanate groups of the polyisocyanate.

It is important for the polyol used in producing the urethane polyol prepolymer to contain a polyether polyol in order to obtain natural leather-like touch and feeling. The conventional other polyol can be used together with the polyether polyol. Examples of the other polyol include polyester polyol, polycarbonate polyol, acryl polyol, polyolefin polyol, castor oil polyol and silicone-modified polyol. Those can be used alone or as mixtures of two or more thereof.

On the other hand, the polyisocyanate that can be used in producing the urethane polyol prepolymer is not particularly limited, and examples thereof include aromatic diisocyanates such as phenylene diisocyanate, tolylene diisocyanate (TDI), 4,4′-diphenylmethane diisocyanate (MDI), 2,4′-diphenylmethane diisocyanate, naphthalene diisocyanate and xylylene diisocyanate; aliphatic diisocyanates or alicyclic diisocyanates, such as hexamethylene diisocyanate, lysine diisocyanate, cyclohexane diisocyanate, isophorone diisocyanate (IPDI), dicyclohexylmethane diisocyanate and tetramethylxylylene diisocyanate; and polymeric MDI containing a dimer or a trimer of 4,4′-diphenylmethane diisocyanate (MDI). Of those, 4,4′-diphenylmethane diisocyanate (MDI) is preferred in the point that it is easy to control a curing reaction.

An equivalent ratio of hydroxyl group/isocyanate group in reacting the polyol and the polyisocyanate is preferably from 1.1 to 3.5, more preferably from 1.2 to 2.5, and further preferably from 1.2 to 1.8. Where the equivalent ratio is less than 1.1, both terminals of the prepolymer are difficult to have hydroxyl groups, and a molecular weight may be increased by reacting the isocyanate group remaining in the prepolymer with ambient moisture, thereby viscosity may be increased. As a result, workability may be deteriorated. Where the equivalent ratio exceeds 3.5, unreacted hydroxyl groups may remain in reacting the prepolymer and the urethane hardener, and a polyurethane resin obtained by curing may have poor properties.

Production of the urethane polyol prepolymer can use the conventional various methods, and is not particularly limited. For example, a method of mixing water-removed polyol and polyisocyanate in given proportions, heating the resulting mixture and then reacting the mixture in a batchwise system, and a method of heating water-removed polyol and polyisocyanate, respectively, introducing those into an extruder in given proportions, and reacting those in a continuous extrusion reaction system can be used.

The urethane polyol prepolymer thus obtained has a softening temperature of preferably from 20 to 100° C., and more preferably from 40 to 70° C. Where the softening temperature is less than 20° C., the polyurethane resin obtained by curing may have low softening temperature, and may have poor heat resistance and strength. Where the softening temperature exceeds 100° C., high temperature may be required to obtain a viscosity suitable for processing, and workability may be deteriorated.

If required and necessary, the urethane polyol prepolymer may contain optional components such as urethanation catalysts, crosslinking agents, silane coupling agents, fillers, thixotropy-imparting agents, tackifiers, waxes, heat stabilizers, light stabilizers, fluorescent brighteners, foaming agents, thermoplastic resins, thermosetting resins, dyes, pigments, flame retardants, conductivity-imparting agents, antistatic agents, moisture permeability improvers, water repellents, oil repellents, hollow foams, crystallization water-containing compounds, water absorbents, moisture absorbents, deodorants, foam-controlling agents, defoamers, fungicides, preservatives, algaecides, pigment dispersants, inert gases, antiblocking agents, hydrolysis inhibitors and thickeners, in a range that properties of the polyurethane resin obtained by curing are not impaired. Those optional components can be used alone or as mixtures of two or more thereof. Above all, urethanation catalysts are preferably used to reduce process load and improve properties of artificial leather.

Polyisocyanate is used as the urethane hardener (urethane curing agent) reacted with the urethane polyol prepolymer. The polyisocyanate is not particularly limited, and examples thereof include tolylene diisocyanate (TDI), 4,4′-diphenylmethane diisocyanate (MDI), modified diphenylmethane diisocyanate, naphthalene diisocyanate, phenylene diisocyanate, hexamethylene diisocyanate, lysine diisocyanate, cyclohexane diisocyanate, isophorone diisocyanate (IPDI), xylene diisocyanate, tetramethylxylene diisocyanate, norbornene diisocyanate, triphenylmethane triisocyanate, polyphenyl polymethylene polyisocyanate, polyisocyanate containing a carbodiimide group, polyisocyanate containing an alphanate group, and polyisocyanate containing an isocyanurate group. Those can be used alone or as mixtures of two or more thereof. Of those, 4,4′-diphenylmethane diisocyanate (MDI) is preferably used in that reaction rate to moisture is high as compared with reaction rate to a prepolymer, and prior to the completion of a curing reaction of the prepolymer, carbon dioxide gas is generated, thereby a surface layer in a good foamed state is easy to obtain.

In the present invention, the urethane hardener can use a compound obtained by reacting a polyol and a polyisocyanate under the condition that isocyanate groups of the polyisocyanate are excess to hydroxyl groups of the polyol, other than the above polyisocyanate. This compound can constitute a base compound in forming a polyurethane resin, as a urethane polyisocyanate prepolymer. By using the urethane polyisocyanate prepolymer as a urethane hardener, the effect as a chain extender is obtained in addition to the action as a urethane hardener. As a result, flexibility of a polyurethane resin obtained by curing can be improved.

The polyol and polyisocyanate that can be used in producing the urethane polyisocyanate prepolymer used as a urethane hardener is not particularly limited. For example, the same polyol and polyisocyanate as used in the production of the urethane polyol prepolymer can be used. Those can be used alone or mixtures of two or more thereof. Of those, as the polyol, polyether polyol is preferred from the point of natural leather-like touch and feeling, and polycarbonate polyol is preferred from the points of light resistance and heat resistance. As the polyisocyanate, 4,4′-diphenylmethane diisocyanate (MDI) is preferred in that it is easy to control a curing reaction.

An equivalent ratio of isocyanate group/hydroxyl group in reacting the polyol and the polyisocyanate to produce the urethane polyisocyanate prepolymer is preferably from 1.1 to 10, and more preferably from 2 to 5. Where the equivalent ratio is less than 1.1, both terminals of the prepolymer are difficult to have isocyanate groups, and not only the action as a urethane hardener may become insufficient, but foamability may be decreased. Where the equivalent ratio exceeds 10, flexibility of the polyurethane resin obtained by curing may be deteriorated.

In the present invention, the surface layer comprises a solventless polyurethane resin formed by a reaction between the urethane polyol prepolymer and the urethane hardener. An equivalent ratio of isocyanate group/hydroxyl group in reacting the urethane polyol prepolymer and the urethane hardener is preferably from 1.0 to 2.0, and more preferably from 1.1 to 1.3. Where the equivalent ratio is less than 1.0, unreacted prepolymer may remain. As a result, the polyurethane resin obtained by curing may have poor properties, and may not obtain the desired degree of foaming. Where the equivalent ratio exceeds 2.0, the curing reaction may proceed excessively, and touch and feeling may be coarse and hard. In this case, the amount of the urethane hardener used is generally from 3 to 50 parts by weight, preferably from 5 to 40 parts by weight, and more preferably from 5 to 20 parts by weight, per 100 parts by weight of the urethane polyol prepolymer, although depending on a molecular weight of the prepolymer and the urethane hardener.

Weight proportion of the polyether polyol in reacting the urethane polyol prepolymer (obtained by reacting a polyol containing polyether polyol, and a polyisocyanate) with the urethane hardener is required to be 40% by weight or more, and is preferably from 40 to 80% by weight, and more preferably 40 to 50% by weight, based on the total weight of the urethane polyol prepolymer and the urethane hardener. The polyether polyol used herein means a polyol used as an essential raw material in producing the urethane polyol prepolymer. In the case of using the urethane polyisocyanate prepolymer produced using polyether polyol, as the urethane hardener, the raw material polyether polyol is included. Where the amount of the polyether polyol is less than 40% by weight, touch and feeling may be coarse and hard.

The surface layer comprising the polyurethane resin has a degree of foaming of preferably from 1.3 to 2.0 times, and more preferably from 1.4 to 1.7 times. Where the degree of foaming is less than 1.3 times, touch and feeling may be coarse and hard. Where the degree of foaming exceeds 2.0 times, abrasion resistance may be poor.

The degree of foaming is obtained as follows. Only a surface layer part on an electron micrograph (50-fold magnification) of a cross-section in a thickness direction of artificial leather is loaded in a personal computer with a scanner, and a foamed part is whitened. Colors of the foamed part and the non-foamed part are binarized with white and black, and white dot parts are counted by integration. A degree of foaming is obtained by the following formula.

Degree of foaming=(Area of foamed part+area of non-formed part)/Area of non-foamed part

The surface layer has a thickness of preferably from 100 to 300 μm, and more preferably from 150 to 250 μm. Where the thickness is less than 100 μm, touch and feeling may be coarse and hard. Where the thickness exceeds 300 μm, abrasion resistance may be poor.

The polyurethane resin constituting the surface layer is required to have 100% modulus value of from 5 to 50 N/cm, preferably from 7 to 40 N/cm, and more preferably from 20 to 30 N/cm. Where the 100% modulus value is less than 5 N/cm, abrasion resistance may be poor. Where the 100% modulus value exceeds 50 N/cm, touch and feeling may be coarse and hard.

The surface layer is laminated on one side of the fibrous substrate through an adhesive layer. This constitution permits to suppress excessive permeation of the polyurethane resin (the prepolymer composition) constituting the surface layer into the fibrous substrate and formation of ununiform pores in the surface layer, that are possibly generated in the case of directly laminating the surface layer on the fibrous substrate, thereby natural leather-like touch and feeling can be provided.

In the present invention, the adhesive layer comprises a polyurethane resin formed by a moisture curing reaction of a urethane polyisocyanate prepolymer. The urethane polyisocyanate prepolymer used herein means a urethane prepolymer having an isocyanate group at the molecular terminal. The polyurethane resin is formed by reacting the isocyanate group present at the molecular terminal of the urethane polyisocyanate prepolymer with moisture in the atmosphere.

The polyol and the polyisocyanate, usable in producing the urethane polyisocyanate prepolymer are not particularly limited. For example, the same polyol and polyisocyanate as used in the production of the urethane polyol prepolymer for the formation of the surface layer as described above can be used. Those can be used alone or as mixtures of two or more thereof. Above all, as the polyol, polyether polyol and polycarbonate polyol are preferred from the point of hydrolysis resistance, and polycarbonate polyol is more preferred from the points of light resistance and heat resistance. As the polyisocyanate, 4,4′-diphenylmethane diisocyanate (MDI) is preferred in that it is easy to control a curing reaction.

The adhesive layer has a thickness of preferably from 10 to 70 μm, more preferably from 10 to 50 and further preferably from 15 to 25 μm. Where the thickness is less than 10 abrasion resistance may be poor. Where the thickness exceeds 70 μm, touch and feeling may be coarse and hard.

Peel strength between the adhesive layer and the fibrous substrate is preferably from 0.5 to 5.0 kg/cm, more preferably from 0.5 to 2.0 kg/cm, and further preferably from 1.0 to 1.7 kg/cm. Where the peel strength is less than 0.5 kg/cm, abrasion resistance may be poor. Where the peel strength exceeds 5.0 kg/cm, touch and feeling may be coarse and hard.

The artificial leather for automobile interior materials according to the present invention comprises a fibrous substrate, a surface layer laminated on one side of the fibrous substrate through an adhesive layer, and a protective layer laminated on the surface of the surface layer. This constitution permits to improve abrasion resistance. In the present invention, the protective layer means a general name of a resin layer as an outermost layer, which is formed on the surface of the surface layer and protects the surface layer, and comprises at least one resin layer. The protective layer can comprise two or more resin layers having the same or different composition.

In the present invention, the protective layer comprises a polyurethane resin. The polyurethane resin is not particularly limited, and examples thereof include a polyether type polyurethane resin, polyester type polyurethane resin and a polycarbonate type polyurethane resin. Those resins can be used alone or as mixtures of two or more thereof. Of those, the polycarbonate type polyurethane resin is preferably used from the points of durability and light resistance. Form of the polyurethane resin is not limited, and any polyurethane resins can be used, regardless of a solventless type, a hot-melt type, a solvent type and an aqueous type, and regardless of one-component type and two-component curing type. The polyurethane resin can appropriately be selected according to the purpose and the use.

If required and necessary, the polyurethane resin may contain optional components such as urethanation catalysts, crosslinking agents, silane coupling agents, fillers, thixotropy-imparting agents, tackifiers, waxes, heat stabilizers, light stabilizers, fluorescent brighteners, foaming agents, thermoplastic resins, thermosetting resins, dyes, pigments, flame retardants, conductivity-imparting agents, antistatic agents, moisture permeability improvers, water repellents, oil repellents, hollow foams, crystallization water-containing compounds, water absorbents, moisture absorbents, deodorants, foam-controlling agents, defoamers, fungicides, preservatives, algaecides, pigment dispersants, inert gases, antiblocking agents, hydrolysis inhibitors, delusterants, touch improvers, slip improvers, and thickeners, in a range that properties of the polyurethane resin are not impaired. Those optional components can be used alone or as mixtures of two or more thereof.

The protective layer has a thickness of preferably from 10 to 150 μm, and more preferably from 20 to 80 μm. Where the thickness is less than 10 μm, it is difficult to uniformly form the protective layer, and the protective layer may partially be not formed. Where the thickness exceeds 150 μm, touch and feeling may be coarse and hard.

The method for producing artificial leather for automobile interior materials according to the present invention is described below.

The production method includes:

a step of mixing a urethane polyol prepolymer in a heated state and an urethane hardener to prepare a prepolymer composition,

a step of applying the prepolymer composition in a heated state to a releasable substrate to form a surface layer, and

a step of applying a urethane polyisocyanate prepolymer in a heated state to the surface layer, and bonding a fibrous substrate to the coated surface.

In the step of forming the surface layer, the prepolymer composition may directly be applied to the releasable substrate (embodiment (1) below) or the protective layer may be formed on the releasable substrate and then the prepolymer composition may be formed on the protective layer (embodiment (2) below), so long as the prepolymer composition is applied to the releasable substrate.

In more detail, the artificial leather for automobile interior materials can be produced by, for example, the following methods.

(1) A prepolymer composition obtained by mixing a urethane polyol prepolymer in a heated state and a urethane hardener is applied to a releasable substrate, if necessary, followed by heat treatment and aging treatment. Thus, a surface layer is formed. A urethane polyisocyanate prepolymer in a heated state is then applied to the surface of the surface layer, and a fibrous substrate is bonded to the coated surface during the state that the urethane polyisocyanate prepolymer has viscosity, followed by aging treatment. The releasable substrate is peeled, and a composition containing a polyurethane resin is applied to the surface of the exposed surface layer, if necessary, followed by heat treatment and aging treatment. Thus, a protective layer is formed.

(2) A composition containing a polyurethane resin is applied to a releasable substrate, if necessary, followed by heat treatment and aging treatment. Thus, a protective layer is formed. A prepolymer composition obtained by mixing a urethane polyol prepolymer in a heated state and a urethane hardener is applied to the surface of the protective layer, if necessary, followed by heat treatment and aging treatment. Thus, a surface layer is formed. A urethane polyisocyanate prepolymer in a heated state is applied to the surface of the surface layer, and a fibrous substrate is bonded to the coated surface during the state that the urethane polyisocyanate prepolymer has viscosity, followed by aging treatment. Finally, the releasable substrate is peeled.

Of the methods (1) and (2) above, the method (2) is preferred for the reasons that a thickness of a protective layer can easily be adjusted and a uniform layer can be formed. The explanation is given below by reference to the method (2), but various explanatory items such as an application method of a resin and heat treatment are basically the items common to the case of using the method (1).

The method of applying the polyurethane resin composition to the releasable substrate in order to form the protective layer can use conventional various methods, and is not particularly limited. For example, methods using apparatuses such as reverse roll coater, spray coater, roll coater, gravure coater, kiss roll coater, knife coater, comma coater and T-die coater can be used. Of those, application with knife coater or comma coater is preferably used in the point that a uniform thin film layer can be formed.

The releasable substrate used in the present invention is not particularly limited. Films comprising resins having releasability by themselves to a polyurethane resin (for example, olefin resin, silicone resin and fluorine resin; hereinafter referred to as a release agent), and release papers, release fabrics and release films, obtained by laminating a release layer comprising the release agent on a substrate such as papers, fabrics and films, can be used. The releasable substrate may have concave-convex patterns. Use of such a releasable substrate permits to impart designs to the surface of artificial leather.

Application thickness of the polyurethane resin composition is appropriately determined according to the thickness of the protective layer.

If required and necessary, heat treatment may be conducted. The heat treatment is conducted to evaporate a solvent in the polyurethane resin composition and to dry a resin. In the case of using a crosslinking agent causing a crosslinking reaction by heat and in the case of using a two-component curing resin, the heat treatment is conducted to promote a reaction and to form a coating film having sufficient strength. The heat treatment temperature is preferably from 50 to 150° C., and more preferably from 60 to 120° C. Where the heat treatment temperature is less than 50° C., the heat treatment may require much time, process load may be increased, and crosslinking of a resin may be insufficient. As a result, abrasion resistance may be poor. Where the heat treatment temperature exceeds 150° C., feeling of artificial leather may be coarse and hard. The heat treatment time is preferably from 2 to 20 minutes, and more preferably from 2 to 10 minutes. Where the heat treatment time is less than 2 minutes, crosslinking of a resin may be insufficient, and abrasion resistance may be poor. Where the heat treatment time exceeds 20 minutes, processing rate may be decreased, and process load may be increased.

In the case of using a hot-melt type resin as the polyurethane resin, a coating film can be formed by applying a heat-melted resin to the surface of the releasable substrate and then cooling the resin. Therefore, heat treatment is not necessary.

If required and necessary, an aging treatment is conducted to complete the reaction. Thus, a protective layer is formed on the releasable substrate.

Subsequently, a prepolymer composition obtained by mixing a urethane polyol prepolymer in a heated state and a urethane hardener is applied to the surface of the protective layer formed on the releasable substrate.

Heating temperature of the urethane polyol prepolymer is appropriately set in conformity with a softening temperature of the urethane polyol prepolymer. The heating temperature is set to a temperature preferably 10 to 80° C. higher, and more preferably 20 to 60° C. higher, than the softening temperature. Where the heating temperature is a temperature less than 10° C. higher than the softening temperature of the prepolymer, viscosity of the prepolymer may be high, and workability at the application may be deteriorated. Where the heating temperature is a temperature more than 80° C. higher than the softening temperature of the prepolymer, it may be impossible to control a curing reaction. The heating temperature is set to a range of generally from 30 to 150° C., and preferably from 40 to 120° C. Heating of the prepolymer is conducted in a raw material tank capable of controlling a temperature.

A mixing head having a structure capable of heating and heat-retaining is used to mix the urethane polyol prepolymer in a heated state and the urethane hardener. Those materials are mixed and stirred in given proportions, and then fed to an application apparatus.

A method of applying the prepolymer composition to the surface of the protective layer can use the conventional various methods, and is not particularly limited. Examples of the method include methods using apparatuses such as spray coater, roll coater, knife coater, comma coater and T-die coater. Of those, application with knife coater or comma coater is preferred from the point that a uniform thin film layer can be formed.

The prepolymer composition has an application thickness of preferably from 50 to 230 and more preferably from 100 to 200 μm. By setting the application thickness to this range, a surface layer having a thickness of preferably from 1.3 to 2.0 times, and more preferably from 1.4 to 1.7 times, the application thickness can be obtained. Consequently, a surface layer having a thickness of preferably from 100 to 300 μm, and more preferably from 150 to 250 μm, is formed.

After applying the prepolymer composition to the releasable substrate, heat treatment is preferably conducted. Curing reaction between the urethane polyol prepolymer and the urethane hardener proceeds at normal temperature, and therefore, heat treatment is not always required. However, because the curing reaction is promoted by heat treatment, the heat treatment is preferably conducted from the point of production efficiency.

The heat treatment temperature in this case can appropriately be selected according to a prepolymer and a urethane hardener selected, additives optionally used, an application thickness and the like. The heat treatment temperature is preferably from 90 to 150° C., and more preferably from 100 to 130° C. Where the heat treatment temperature is less than 90° C., the effect of promoting a reaction by conducting heat treatment may not sufficiently be obtained. Where the heat treatment temperature exceeds 150° C., it may be impossible to control a curing reaction, and processing stability may be poor. Heat treatment time is preferably from 30 seconds to 5 minutes, and more preferably from 1 to 3 minutes. Where the heat treatment time is less than 30 seconds, the effect of promoting a reaction by conducting heat treatment may not sufficiently be obtained. Where the heat treatment time exceeds 5 minutes, process load may be increased.

If required and necessary, an aging treatment is conducted. Reaction rate between the urethane polyol prepolymer and the urethane hardener greatly varies depending on kind and amount of the prepolymer and urethane hardener selected, and additives (particularly, urethanation catalyst) optionally used. Therefore, it is necessary to appropriately set the aging treatment conditions depending on the conditions selected. In general, the aging treatment is conducted at room temperature for about 1 day to 1 week. At this stage, curing reaction between the prepolymer and the urethane hardener is completed. Where the curing reaction is not completed at the final stage, properties such as abrasion resistance may be poor. Even after bonding the surface layer to the fibrous substrate through the urethane polyisocyanate prepolymer, the aging treatment is conducted in order that the prepolymer is subjected to a moisture curing reaction, as described hereinafter. Therefore, at this stage, the curing reaction between the urethane polyol prepolymer and the urethane hardener is not always required to be completed, and it is sufficient so long as the curing reaction proceeds to an extent of not adversely affect the post-step.

Subsequently, the urethane polyisocyanate prepolymer in a heated state is applied to the surface of the surface layer out of the surface layer and the protective layer that are formed on the releasable substrate. Heating temperature of the urethane polyisocyanate prepolymer is appropriately set in conformity with the urethane polyisocyanate prepolymer selected. Application method can use the conventional various methods, and is not particularly limited. For example, methods using apparatuses such as spray coater, roll coater, knife coater, comma coater and T-die coater can be used. Of those, application with knife coater or comma coater is preferably used in the point that a uniform thin film layer can be formed.

Application thickness of the urethane polyisocyanate prepolymer is appropriately determined according to a thickness of the adhesive layer.

The fibrous substrate is bonded to the surface of the urethane polyisocyanate prepolymer during the state that the urethane polyisocyanate prepolymer (part thereof undergoes a moisture curing reaction, and a polyurethane resin is formed) has viscosity, followed by cooling to room temperature and conducting an aging treatment.

Reaction rate between the urethane polyisocyanate polymer and moisture in the atmosphere greatly varies depending on kind and amount of the prepolymer selected and additives (particularly, urethanation catalyst) optionally used. Therefore, it is necessary to appropriately set the aging treatment conditions depending on the conditions selected. In general, the aging treatment is conducted at room temperature for about 1 day to 1 week. At this stage, moisture curing reaction of the prepolymer is completed. Where the curing reaction is not completed, properties such as abrasion resistance may be poor.

By this, a sheet-like material having the releasable substrate 5 on the surface of the protective layer 4 is obtained as shown in FIG. 2. Finally, the releasable substrate 5 is peeled, and the artificial leather for automobile interior materials of the present invention can be obtained.

### EXAMPLES

The present invention is described in more detail below by reference to Examples, but the invention is not construed as being limited to the Examples. “Parts” in the Examples are by weight. The artificial leather obtained was evaluated according to the following methods.

### Touch

One test piece having A4 size (width: 210 mm, length: 297 mm) was collected. The test piece was slowly moved 10 cm while pressing the surface of artificial leather (surface of a protective layer) with a bulb portion (inner surface) of a finger in a state that the test piece was placed on a flat plate. Touch in this movement was judged according to the following standards.

Good: Surface gets distorted and gives sensation that surface of artificial leather tightly fits to the bulb of a finger.

Moderate: Surface slightly gets distorted but does not give sensation that surface of artificial leather tightly fits to the bulb of a finger.

Poor: Surface does not get distorted at all and does not give sensation that surface of artificial leather tightly fits to the bulb of a finger.

### Feeling

One test piece having 150 mm square was collected. When the test piece was pushed with a load of 500 g using a touch tester (trade name: ST300 Leather Softness Tester, manufactured by BLC Leather Technology Center Ltd.), strain measurement value (BLC value) was measured. The larger strain measurement value indicates feeling being softer.

### Abrasion Resistance

One test piece having a width of 70 mm and a length of 300 mm was collected from a longitudinal direction of artificial leather. Urethane foam having a width of 70 mm, a length of 300 mm and a thickness of 10 mm was fitted to the back of the test piece. A wire having a diameter of 4.5 mm was arranged at a center of lower surface of the urethane foam, load of 9.8N was applied to a friction element covered with cotton cloth over the wire in parallel to the wire, and the test piece was abraded with the friction element. The friction element was reciprocated on the surface of the test piece 20,000 times with a distance of 140 mm at a speed of 60 reciprocations/min for abrasion. The test piece after abrasion was visually observed, and judged according to the following standard.

Good: Abrasion trace cannot substantially be confirmed.

Fair: Abrasion trace can be confirmed, but fibrous substrate is not exposed.

Poor: Abrasion trace can be confirmed, and fibrous substrate is exposed.

### 100% Modulus Value

A prepolymer composition was applied to a flat release paper (trade name: EU130TPD, manufactured by Lintec Corporation) using a bar coater such that a thickness of a cured film is 200 μm. Thus formed prepolymer-composition film was heat-treated at 120° C. for 2 minutes with a drier, and then subjected to aging treatment for 1 day in the atmosphere of a temperature of 20±2° C. and a humidity of 65±5% RH. Thus, a cured film was prepared. Three test pieces having a width of 30 mm (B) and a length of 100 mm were collected from the cured film. The respective test piece was clipped with a clamp of a tensile tester (trade name: AUTOGRAPH AG-X, manufactured by Shimadzu Corporation) with a clamping width of 30 mm and a clamping interval of 50 mm in the atmosphere of a temperature of 20±2° C. and a humidity of 65±5% RH. The test piece was pulled in a tensile rate of 200 mm/min, and a load (P) when a stroke distance was 50 mm was measured. 100% modulus value was calculated by the following formula. The result was shown by an average value of three test pieces. Smaller 100% modulus value indicates the test piece being softer.

100% modulus value (N/cm)=P(Load(N) when stroke distance is 50 mm)/B(width of cured film (cm))

### Peel Strength

Three test pieces having a width of 30 mm and a length of 120 mm were collected from a longitudinal direction of artificial leather. A polyurethane resin layer and a fibrous substrate were peeled 40 mm from one edge of the test piece. The peeled polyurethane resin layer and fibrous substrate were clipped with a clamp of a tensile tester (trade name: AUTOGRAPH G-100A, manufactured by Shimadzu Corporation) with a clamping width of 30 mm so as not to generate sag in the atmosphere of a temperature of 20±2° C. and a humidity of 65±5% RH. The polyurethane resin layer was peeled at a movement rate of the clamp of 200 m/min. The maximum load (kg/cm) at the peeling was measured. The result was shown by an average value of three test pieces.

The urethane polyol prepolymer was produced as follows.

### Production Example 1

100 parts of a polycarbonate polyol (trade name: KURARAY POLYOL C2090, manufactured by Kuraray Co., Ltd.) having a number average molecular weight of 2,000, and 100 parts of a polyether polyol (trade name: PTMG 2000, manufactured by Sanyo Chemical Industries, Ltd.) were placed in a 1 liter four-necked flask maintained at 60° C., and stirred. 19 parts of 4,4′-diphenylmethane diisocyanate (MDI) were placed in the flask, and the resulting mixture was stirred at 80° C. until isocyanate groups were consumed (equivalent ratio (hydroxyl group/isocyanate group) is 1.3). Thus, a urethane polyol prepolymer was obtained.

### Production Example 2

170 parts of a polyester polyol (trade name: KURARAY POLYOL P2010, manufactured by Kuraray Co., Ltd.) having a number average molecular weight of 2,000, and 30 parts of a polyether polyol (trade name: PTMG 2000, manufactured by Sanyo Chemical Industries, Ltd.) having a number average molecular weight of 2,000 were placed in a 1 liter four-necked flask maintained at 60° C., and stirred. 19 parts of 4,4′-diphenylmethane diisocyanate (MDI) were placed in the flask, and the resulting mixture was stirred at 80° C. until isocyanate groups were consumed (equivalent ratio (hydroxyl group/isocyanate group) is 1.3). Thus, a urethane polyol prepolymer was obtained.

### Production Example 3

200 parts of a polycarbonate polyol (trade name: KURARAY POLYOL C2090, manufactured by Kuraray Co., Ltd.) having a number average molecular weight of 2,000 were placed in a 1 liter four-necked flask maintained at 60° C., and stirred. 15 parts of 4,4′-diphenylmethane diisocyanate (MDI) were placed in the flask, and the resulting mixture was stirred at 80° C. until isocyanate groups were consumed (equivalent ratio (hydroxyl group/isocyanate group) is 1.7). Thus, a urethane polyol prepolymer was obtained.

### Production Example 4

80 parts of a polycarbonate polyol (trade name: KURARAY POLYOL C2090, manufactured by Kuraray Co., Ltd.) having a number average molecular weight of 2,000, and 120 parts of a polyether polyol (trade name: PTMG 2000, manufactured by Sanyo Chemical Industries, Ltd.) having a number average molecular weight of 2000 were placed in a 1 liter four-necked flask maintained at 60° C., and stirred. 19 parts of 4,4′-diphenylmethane diisocyanate (MDI) were placed in the flask, and the resulting mixture was stirred at 80° C. until isocyanate groups were consumed (equivalent ratio (hydroxyl group/isocyanate group) is 1.3). Thus, a urethane polyol prepolymer was obtained.

### Production Example 5

30 parts of a polycarbonate polyol (trade name: KURARAY POLYOL C2090, manufactured by Kuraray Co., Ltd.) having a number average molecular weight of 2,000, and 170 parts of a polyether polyol (trade name: PTMG 2000, manufactured by Sanyo Chemical Industries, Ltd.) having a number average molecular weight of 2000 were placed in a 1 liter four-necked flask maintained at 60° C., and stirred. 19 parts of 4,4′-diphenylmethane diisocyanate (MDI) were placed in the flask, and the resulting mixture was stirred at 80° C. until isocyanate groups were consumed (equivalent ratio (hydroxyl group/isocyanate group) is 1.3). Thus, a urethane polyol prepolymer was obtained.

### Production Example 6

110 parts of a polycarbonate polyol (trade name: KURARAY POLYOL C2090, manufactured by Kuraray Co., Ltd.) having a number average molecular weight of 2,000, and 90 parts of a polyether polyol (trade name: PTMG 2000, manufactured by Sanyo Chemical Industries, Ltd.) having a number average molecular weight of 2000 were placed in a 1 liter four-necked flask maintained at 60° C., and stirred. 19 parts of 4,4′-diphenylmethane diisocyanate (MDI) were placed in the flask, and the resulting mixture was stirred at 80° C. until isocyanate groups were consumed (equivalent ratio (hydroxyl group/isocyanate group) is 1.3). Thus, a urethane polyol prepolymer was obtained.

### Production Example 7

130 parts of a polycarbonate polyol (trade name: KURARAY POLYOL C2090, manufactured by Kuraray Co., Ltd.) having a number average molecular weight of 2,000, and 70 parts of a polyether polyol (trade name: PTMG 2000, manufactured by Sanyo Chemical Industries, Ltd.) having a number average molecular weight of 2000 were placed in a 1 liter four-necked flask maintained at 60° C., and stirred. 19 parts of 4,4′-diphenylmethane diisocyanate (MDI) were placed in the flask, and the resulting mixture was stirred at 80° C. until isocyanate groups were consumed (equivalent ratio (hydroxyl group/isocyanate group) is 1.3). Thus, a urethane polyol prepolymer was obtained.

### Example 1

Formulation 1 (Formulation of protective layer)

| | | |
|---|---|---|
| Polycarbonate type polyurethane resin | 100 | parts |
| (trade name: CRYSBON NY-328, manufactured by DIC | | |
| Corporation) | | |
| Dimethyl formamide (DMF) | 40 | parts |
| Carbon black pigment | 15 | parts |
| (trade name: DIALAC BLACK L-1770S, manufactured by | | |
| DIC Corporation) | | |
| Crosslinking agent | 2 | parts |
| (trade name: BARNOCK DN950, manufactured by DIC | | |
| Corporation) | | |
| Viscosity was adjusted to 2,000 cps | | |
| (20 ± 2° C.). | | |

Formulation 2 (Formulation of surface layer)

| | | |
|---|---|---|
| Urethane polyol prepolymer of Production Example 1 | 100 | parts |
| Urethane hardener | 5 | parts |
| (Carbodiimide-modified polymethylene polyphenyl | | |
| polyisocyanate, trade name: COSMONATE LL, | | |
| manufactured by Mitsui Chemical Polyurethane | | |
| Co., Ltd.) | | |
| Carbon black pigment | 2 | parts |
| (trade name: POLYTON BLACK, manufactured by DIC | | |
| Corporation) | | |
| Amine type urethanation catalyst | 1 | part |
| (trade name: TOYOCAT-DT, manufactured by Tosoh | | |
| Corporation) | | |

Preparation method of Formulation 2: Carbon black pigment and an amine type urethanation catalyst were added to a urethane polyol prepolymer heated to 100° C., and the resulting mixture was stirred to disperse the pigment and the catalyst. A urethane hardener heated to 40° C. was added to the mixture, followed by stirring. The resulting mixture was immediately subjected to application operation.

The polyurethane resin composition prepared according to Formulation 1 above was applied to a release paper having embossing grain patterns (trade name: R-8, manufactured by Lintec Corporation) with a comma coater in a sheet form such that an application thickness was 150 μm. Thus formed resin-composition film was heat-treated at 100° C. for 3 minutes with a drier. Thus, a protective layer having a thickness of 30 μm was formed.

Then, the prepolymer composition prepared according to Formulation 2 above was applied to the surface of the protective layer formed on the release paper with a comma coater in a sheet form such that an application thickness was 150 μm. Thus formed prepolymer-composition film was heat-treated at 100° C. for 5 minutes with a drier. The film was then subjected to an aging treatment in the atmosphere of room temperature of 20±2° C. and a humidity of 65±5% RH for 1 day, thereby forming a surface layer having a thickness of 210 μm on the protective layer. The surface layer had a degree of foaming of 1.4.

Subsequently, a urethane polyisocyanate prepolymer (trade name: NH230, manufactured by DIC Corporation) was applied to the surface layer with a comma coater in a sheet form such that an application thickness was 20 μm. The coated surface was bonded to a polyester tricot fabric during the state that the urethane polyisocyanate prepolymer had viscosity. The resulting laminate was pressed under a load of 5 kg/m² with a mangle, and was then subjected to an aging treatment in the atmosphere of room temperature of 20±2° C. and a humidity of 65±5% RH for 3 days. The release paper was peeled from the laminate. Thus, artificial leather for automobile interior materials of the present invention was obtained. The adhesive layer had a thickness of 15 μm.

### Examples 2 to 6 and Comparative Examples 1 to 5

Artificial leather was obtained in the same manner as in Example 1 according to Table 1. In Examples 4 to 6 and Comparative Example 5, 4,4′-diphenylmethane diisocyanate (MDI) was used as the urethane hardener of Formulation 2 in place of COSMONATE LL.

### Comparative Example 6

Artificial leather was obtained in nearly the same manner as in Example 1, except that an adhesive layer was not formed. Specifically, a protective layer was formed on a release paper in the same manner as in Example 1. A prepolymer composition prepared according to Formulation 2 above was applied to the surface of the protective layer with a comma coater in a sheet form such that an application thickness was 150 μm, and heat-treated with drier at 100° C. for 5 minutes. The coated surface was bonded to a polyester tricot fabric during the state that the prepolymer composition had viscosity. The resulting laminate was pressed under a load of 5 kg/m² with a mangle, and was then subjected to an aging treatment in the atmosphere of room temperature of 20±2° C. and a humidity of 65±5% RH for 1 day. Thus, a surface layer having a thickness of 210 μM was formed on the protective layer. The release paper was peeled from the laminate. Thus, artificial leather was obtained. The surface layer had a degree of foaming of 1.4.

### Comparative Example 7

Artificial leather was obtained in nearly the same manner as in Example 1, except for using a polyurethane resin composition prepared according to Formulation 3 below in the adhesive layer. Specifically, a protective layer and a surface layer were formed on a release paper in the same manner as in Example 1. A polyurethane resin composition prepared according to Formulation 3 below was applied to the surface layer with a comma coater in a sheet form such that an application thickness was 20 μm. The coated surface was bonded to a polyester tricot fabric, and the resulting laminate was pressed under a load of 5 kg/m² with a mangle, and was then heat-treated at 120° C. for 2 minutes with a drier. The release paper was peeled from the laminate. Thus, artificial leather was obtained. The adhesive layer had a thickness of 15 μm.

Formulation 3

| | | |
|---|---|---|
| Polycarbonate type polyurethane resin | 100 | parts |
| (trade name: CRYSBON TA-205-FT, manufactured by DIC | | |
| Corporation) | | |
| Crosslinking agent | 10 | parts |
| (trade name: BARNOCK DN-950, manufactured by DIC | | |
| Corporation) | | |
| Crosslinking accelerator | 1 | part |
| (trade name: CRYSBON ACCEL T-81, manufactured by | | |
| DIC Corporation) | | |
| DMF/MEK (3/2) | 60 | parts |

Viscosity was adjusted to 4,500 cps (20±2° C.)

### Comparative Example 8

Artificial leather was obtained in the same manner as in Example 1, except for using a prepolymer composition prepared according to Formulation 4 below in the surface layer. Specifically, a protective layer was formed on a release paper in the same manner as in Example 1. A prepolymer composition prepared according to Formulation 4 below was applied to the surface of the protective layer with a comma coater in a sheet form such that an application thickness was 150 μm, and heat-treated with drier at 100° C. for 5 minutes. Thus formed prepolymer-composition film was then subjected to an aging treatment in the atmosphere of room temperature of 20±2° C. and a humidity of 65±5% RH for 1 day. Thus, a surface layer having a thickness of 225 μm was formed on the protective layer. The surface layer had a degree of foaming of 1.5. The surface layer was bonded to a polyester tricot fabric through an adhesive layer in the same manner as in Example 1. Thus, artificial leather was obtained. The adhesive layer had a thickness of 15 μm.

Formulation 4

| | |
|---|---|
| Urethane polyisocyanate prepolymer | 100 parts |
| (trade name: NH230, manufactured by DIC | |
| Corporation) | |
| Carbon black pigment | 2 parts |
| (trade name: POLYTON BLACK, manufactured | |
| by DIC Corporation) | |

TABLE 1

| | | | | | | | | | Comparative | |
|---|---|---|---|---|---|---|---|---|---|---|
| | | | Example | | | | | | Example | |
| | | | 1 | 2 | 3 | 4 | 5 | 6 | 1 | 2 |
| Protective | Polyurethane resin | | Formu- | Formu- | Formu- | Formu- | Formu- | Formu- | Formu- | Formu- |
| layer | | | lation 1 | lation 1 | lation 1 | lation 1 | lation 1 | lation 1 | lation 1 | lation 1 |
| | Thickness (μm) | | 30 | 30 | 30 | 30 | 30 | 30 | 30 | 30 |
| Surface | Urethane | Kind | Production | Production | Production | Production | Production | Production | Production | Production |
| layer | polyol | | Example 1 | Example 1 | Example 1 | Example 4 | Example 5 | Example 6 | Example 2 | Example 3 |
| | prepolymer | Equivalent | 1.3 | 1.3 | 1.3 | 1.3 | 1.3 | 1.3 | 1.3 | 1.7 |
| | | ratio | | | | | | | | |
| | | (OH/NCO) | | | | | | | | |
| | | Amount | 100 | 100 | 100 | 100 | 100 | 100 | 100 | 100 |
| | | (parts) | | | | | | | | |
| | Urethane | Kind | LL | LL | LL | MDI | MDI | MDI | LL | LL |
| | hardener | Amount | 5 | 5 | 5 | 5 | 5 | 5 | 5 | 7 |
| | | (parts) | | | | | | | | |

| | Weight of polyether polyol | 44.6 | 44.6 | 44.6 | 54.8 | 77.6 | 41.1 | 13.4 | 0 |
|---|---|---|---|---|---|---|---|---|---|
| | (%) | | | | | | | | |
| | Compounding equivalent | 1.2 | 1.2 | 1.2 | 1.2 | 1.2 | 1.2 | 1.2 | 1.2 |
| | ratio (NCO/OH) | | | | | | | | |
| | Application thickness (μm) | 150 | 150 | 100 | 150 | 150 | 150 | 150 | 150 |
| | Thickness (μm) | 210 | 210 | 130 | 240 | 285 | 195 | 200 | 170 |
| | Degree of foaming | 1.4 | 1.4 | 1.3 | 1.6 | 1.9 | 1.3 | 1.3 | 1.1 |
| | 100% modulus value | 28 | 28 | 28 | 18 | 8 | 47 | 3 | 67 |
| | (N/cm) | | | | | | | | |
| Adhesive | Urethane polyisocyanate | NH230 | NH230 | NH230 | NH230 | NH230 | NH230 | NH230 | NH230 |
| layer | prepolymer | | | | | | | | |
| | Thickness (μm) | 15 | 60 | 15 | 15 | 15 | 15 | 15 | 15 |
| Fibrous substrate | | Tricot | Tricot | Tricot | Tricot | Tricot | Tricot | Tricot | Tricot |
| Evaluation | Touch | Good | Good | Moderate | Good | Good | Moderate | Moderate | Poor |
| | Feeling (BLC value) | 4.8 | 3.1 | 4.4 | 4.9 | 5 | 3.5 | 3.5 | 3.8 |
| | Abrasion resistance | Good | Good | Good | Good | Good | Good | Poor | Good |
| | Peel strength (kg/cm) | 1.5 | 4.2 | 1.7 | 1.6 | 1.7 | 1.6 | 1.5 | 1.6 |

| | | | Comparative Example | | | | | |
|---|---|---|---|---|---|---|---|---|
| | | | 3 | 4 | 5 | 6 | 7 | 8 |
| Protective | Polyurethane resin | | Formu- | Formu- | Formu- | Formu- | Formu- | Formu- |
| layer | | | lation 1 | lation 1 | lation 1 | lation 1 | lation 1 | lation 1 |
| | Thickness (μm) | | 30 | 30 | 30 | 30 | 30 | 30 |
| Surface | Urethane | Kind | Production | Production | Production | Production | Production | Formu- |
| layer | polyol | | Example 1 | Example 1 | Example 7 | Example 1 | Example 1 | lation 4 |
| | prepolymer | Equivalent | 1.3 | 1.3 | 1.3 | 1.3 | 1.3 | |
| | | ratio | | | | | | |
| | | (OH/NCO) | | | | | | |
| | | Amount | 100 | 100 | 100 | 100 | 100 | |
| | | (parts) | | | | | | |
| | Urethane | Kind | LL | LL | MDI | LL | LL | |
| | hardener | Amount | 5 | 5 | 5 | 5 | 5 | |
| | | (parts) | | | | | | |

| | Weight of polyether polyol | 44.6 | 44.6 | 32.0 | 44.6 | 44.6 | — |
|---|---|---|---|---|---|---|---|
| | (%) | | | | | | |
| | Compounding equivalent | 1.2 | 1.2 | 1.2 | 1.2 | 1.2 | — |
| | ratio (NCO/OH) | | | | | | |
| | Application thickness (μm) | 350 | 50 | 150 | 150 | 150 | 150 |
| | Thickness (μm) | 770 | 55 | 210 | 210 | 210 | 225 |
| | Degree of foaming | 2.2 | 1.1 | 1.4 | 1.4 | 1.4 | 1.5 |
| | 100% modulus value | 28 | 28 | 59 | 28 | 28 | 78 |
| | (N/cm) | | | | | | |
| Adhesive | Urethane polyisocyanate | NH230 | NH230 | NH230 | None | Formu- | NH230 |
| layer | prepolymer | | | | | lation 3 | |
| | Thickness (μm) | 15 | 15 | 15 | — | 15 | 15 |
| Fibrous substrate | | Tricot | Tricot | Tricot | Tricot | Tricot | Tricot |
| Evaluation | Touch | Good | Poor | Poor | Poor | Poor | Poor |
| | Feeling (BLC value) | 6 | 3.9 | 3.9 | 3.5 | 3.5 | 3.1 |
| | Abrasion resistance | Poor | Poor | Good | Good | Good | Good |
| | Peel strength (kg/cm) | 1.4 | 1.7 | 1.5 | 1.2 | 1.1 | 1.8 |

As shown in Table 1, the artificial leathers of the Examples had natural leather-like touch and feeling, and had excellent abrasion resistance. In Examples 3 and 6, the degree of foaming of the surface layer is low as compared with that of other Examples. Therefore, Examples 3 and 6 had slightly poor touch, but had nearly natural leather-like touch.

Contrary to this, in Comparative Example 1, weight of the polyether polyol in the polyurethane resin constituting the surface layer is less than the defined range, and as a result, touch was slightly poor. Furthermore, 100% modulus value of the polyurethane resin is less than the defined range, and as a result, abrasion resistant was poor.

In Comparative Example 2, weight of the polyether polyol in the polyurethane resin constituting the surface layer and a degree of foaming of the surface layer are less than the defined ranges, and additionally, 100% modulus value of the polyurethane resin exceeds the defined range. As a result, touch was poor.

In Comparative Example 3, a degree of foaming of the surface layer exceeds the defined range, and additionally, a thickness of the surface layer exceeds the preferred range. As a result, abrasion resistance was poor.

In Comparative Example 4, a degree of foaming of the surface layer is less than the defined range, and additionally, a thickness of the surface layer is less than the preferred range. As a result, touch was poor. Furthermore, a thickness of the surface layer is extremely small, and as a result, abrasion resistance was poor.

In Comparative Example 5, weight of the polyether polyol in the polyurethane resin constituting the surface layer is less than the defined range, and additionally, 100% modulus value of the polyurethane resin exceeds the defined range. As a result, touch was poor.

In Comparative Example 6, an adhesive layer is not separately provided, and the surface layer combines an adhesive layer. Due to the constitution, the polyurethane resin constituting the surface layer permeates the fibrous substrate, and ununiform pores are formed in the surface layer. As a result, touch was poor.

In Comparative Example 7, because a solvent-type polyurethane resin is used in the adhesive layer, a resin permeates the fibrous substrate. As a result, touch was poor.

In Comparative Example 8, because the urethane polyisocyanate prepolymer is used in the surface layer, 100% modulus value of the polyurethane resin exceeds the defined range. As a result, touch was poor.

The artificial leather according to the present invention can be applied to automobile interior use on the basis of its excellent touch, feeling and abrasion resistance.

1. Artificial leather for automobile interior materials comprising:
a fibrous substrate,
an adhesive layer comprising a polyurethane resin formed by a moisture curing reaction of a urethane polyisocyanate prepolymer, formed on one side of the fibrous substrate,
a surface layer comprising a polyurethane resin formed by a reaction between a urethane polyol prepolymer and a urethane hardener, formed on the adhesive layer, and
a protective layer comprising a polyurethane resin, formed on the surface layer;
wherein the urethane polyol prepolymer used in the formation of the surface layer is obtained by reacting a polyol containing a polyether polyol with a polyisocyanate, a weight proportion of the polyether polyol being 40% by weight or more based on the total weight of the urethane polyol prepolymer and the urethane hardener,
the polyurethane resin constituting the surface layer has 100% modulus value of from 5 to 50 N/cm, and
the surface layer has a degree of foaming of from 1.3 to 2.0 times.

2. The artificial leather for automobile interior materials according to claim 1, wherein the urethane polyol prepolymer is obtained by reacting the polyol containing polyether polyol and the polyisocyanate in an equivalent ratio of hydroxyl group/isocyanate group of from 1.1 to 3.5.

3. The artificial leather for automobile interior materials according to claim 1, wherein the equivalent ratio of isocyanate group/hydroxyl group between the urethane polyol prepolymer and the urethane hardener, used in the formation of the surface layer is from 1.0 to 2.0, and the amount of the urethane hardener used is from 3 to 50 parts by weight per 100 parts by weight of the urethane polyol prepolymer.

4. The artificial leather for automobile interior materials according to claim 1, wherein the urethane hardener used in the formation of the surface layer is a urethane polyisocyanate prepolymer obtained by reacting a polyisocyanate and a polyol in an equivalent ratio of isocyanate group/hydroxyl group of from 1.1 to 10.

5. The artificial leather for automobile interior materials according to claim 1, wherein the surface layer has a thickness of from 100 to 300 mm.

6. The artificial leather for automobile interior materials according to claim 1, wherein weight proportion of the polyether polyol is from 40 to 80% by weight based on the total weight of the urethane polyol prepolymer and the urethane hardener, used in the formation of the surface layer.

7. The artificial leather for automobile interior materials according to claim 1, wherein peel strength between the adhesive layer and the fibrous substrate is from 0.5 to 5.0 kg/cm.

8. A method for producing artificial leather for automobile interior materials according to claim 1 comprising:
a step of mixing a urethane polyol prepolymer in a heated state and a urethane hardener to prepare a prepolymer composition,
a step of applying the prepolymer composition in a heated state to a releasable substrate to form a surface layer, and
a step of applying a urethane polyisocyanate prepolymer in a heated state to the surface layer, and bonding a fibrous substrate to the surface applied with the urethane polyisocyanate prepolymer.
